(19) United States
(12) Patent Application Publication
(10) Pub. No.: US 2026/0077384 A1
(43) Pub. Date: Mar. 19, 2026

(54) DRONE-CRAWLER SYSTEM FOR METAL SURFACE PREPARATION

(71) Applicants: PETRÓLEO BRASILEIRO S.A. - PETROBRAS, Rio de Janeiro (BR); AEROCOM INDUSTRIA E COMERCIO LTDA - AEROCOM, Belo Horizonte (BR)

(72) Inventors: CLAYTON EDUARDO RODRIGUES, São José dos Campos (BR); PAULO HENRIQUE GIUSTI, Rio de Janeiro (BR); ANDRE KOEBSCH, Rio de Janeiro (BR); MARCELO ROBERTI ROCHA FANTAGUZZI, Belo Horizonte (BR); FRANCISCO RIBEIRO FONSECA REIS, Belo Horizonte (BR); IGOR MACHADO MALAQUIAS, Belo Horizonte (BR); DANIEL DE OLIVEIRA ANDRADE, Belo Horizonte (BR); ANTONIO RAFAEL DA SILVA FILHO, Belo Horizonte (BR); GUILHERME ANDRÉ SANTANA, Belo Horizonte (BR)

(73) Assignees: PETRÓLEO BRASILEIRO S.A. - PETROBRAS, Rio de Janeiro (BR); AEROCOM INDUSTRIA E COMERCIO LTDA - AEROCOM, Belo Horizonte (BR)

(21) Appl. No.: 19/326,133

(22) Filed: Sep. 11, 2025

(30) Foreign Application Priority Data
Sep. 18, 2024 (BR) 1020240191900

(51) Int. Cl. B05C 21/00; B25J 11/00

(52) U.S. Cl. CPC B05C 21/00; B25J 11/0075

(57) ABSTRACT

The present application relates to a drone-crawler system for preparing ferromagnetic metal surfaces, comprising a crawler and a drone that operate in coupled and decoupled configurations. The system includes a control system that operates the crawler autonomously or via remote control, a flight control system that operates the drone autonomously or via remote control, a crawler coupling and decoupling system, an adhesion system for ferromagnetic metal surfaces that keeps the crawler fixed to ferromagnetic metal surfaces at any angle relative to the ground, a locomotion system that moves the crawler across any ferromagnetic surface, a surface preparation system that prepares ferromagnetic metal surfaces for subsequent coating application, a decoupling system for ferromagnetic metal surfaces that nullifies the magnetic adhesion force exerted by the magnetic adhesion system, and a coupling system for ferromagnetic metal surfaces that maintains and releases the drone from rest on ferromagnetic metal surfaces.

### CROSS-REFERENCE TO RELATED APPLICATIONS

This application claims priority to Brazilian Application No. BR 1020240191900, filed Sep. 18, 2024, the disclosure of which is herein incorporated by reference in its entirety.

### FIELD

This invention relates to the technical field of maintenance of ships and offshore platforms, drilling platforms and storage tanks, storage spheres and other metal structures exposed to corrosive environments, being applied more specifically in cleaning processes, surface preparation and application of new coatings on ferromagnetic structures to prevent corrosion and ensure structural integrity.

### BACKGROUND

Metal structures are essential in industrial settings due to their robustness and ability to withstand large loads. They provide the solid foundation needed for the efficient operation of warehouses, factories, power plants, ports, platforms and refineries, with the objective of ensuring that industrial operations run smoothly. However, a common challenge faced by these structures is the process of corrosion and paint wear. The exposure of the surface to corrosive elements, such as humidity and aggressive chemicals, leads to the gradual loss of mass of the metal material, which in turn weakens and compromises its physical integrity and safety. To mitigate this corrosive process, periodic painting of metal structures is paramount. The application of a protective layer of paint forms an effective barrier between the metal surface and corrosive agents, extending the life of structures and reducing the interval between costly corrective maintenance. To achieve good paint durability, it is necessary to apply the coating on a properly prepared surface, by removing any contaminants such as oils, water, unknown particles, and corrosion products. The methods for surface preparation are guided by standards such as ISO 8501, ABNT NBR 7348, and SSPC specific to the environment in question. For mechanical tools, for example, standards like ABNT NBR 15239 and SSPC SP3 apply.

In the process of preparing a metal surface for painting, besides removing pre-existing corrosion, it is necessary to ensure an adequate surface finish, generally represented by roughness value, roughness profile, and the percentage of effectively prepared area. These standards assist in this process by creating classification parameters for surface preparation, the most common being the Swedish “Saab Visual Assessment of Surface Cleanliness” (VAC) and the international standards “ISO 8501” and “SSPC/NACE”. Each standard uses a code to specify the surface cleanliness level. For example, the VAC standard uses: SA1 to represent preparation with superficial removal of contaminants without complete elimination of corrosion or rust, and SA3 to represent full preparation to bare metal, where the surface is entirely free of corrosion, rust, and impurities.

The process of preparing metal surfaces is fundamental for the maintenance of structures, machinery, or any other metal assets present in virtually any current production process. This ensures that the protective painting against corrosion will have the durability declared by the manufacturer.

In this context, it is not only the surface preparation process that results in man-hours exposed to accident risk. In hard-to-access locations, such as spherical vessels for liquefied gases, scaffoldings or suspended platforms must be installed to access the structure surface, further increasing HHER. Additionally, inspectors are needed to verify the prepared surface. Beyond safety concerns, which are the primary parameter of any activity, the installation of scaffolds or suspended platforms considerably reduces productivity in surface preparation due to the required man-hours for transportation, assembly, and disassembly of these structures.

The use of man-hours also creates the need to increase operational robustness and safety. Weather and ambient lighting conditions can impede activity to protect the integrity of personnel. Furthermore, despite training, operators are subject to errors that can compromise operation quality, possibly causing rework, damage to equipment, and company assets.

In recent decades, efforts to automate metal surface preparation for painting have intensified. It is evident from the arguments above that such automation has the potential to significantly increase operational efficiency and safety. In the current state of the art, the most successful initiatives use “crawlers,” robots capable of adhering to metal surfaces, generally ferromagnetic, able to move and perform preparation since the surface preparation tools are mounted on the robot itself, substantially reducing the need for human intervention.

To mitigate the problem of man-hours exposed to risk, efforts have been made over the last decades to replace much of human operations with robots. These robots are generally crawler-type, capable of adhering and moving on ferromagnetic metal surfaces, carrying surface preparation tools with them. Trained operators are still needed, but the risk is considerably lower. Although the state of the art already shows satisfactory results, there remains significant room for inventive ideas in automating these processes.

Consequently, the state of the art includes constructive methods and crawler robot configurations. Various magnetic adhesion methods exist, with magnetic wheels and magnetic pads being the main types used. Regarding power supply, some use internal batteries while others employ tethered cables providing external power. However, robust teachings on positioning and moving the crawler to regions of interest, whether for inspection, surface preparation, or other activities, are lacking.

However, in the field of drones, there are state of the art technologies with the capability for these vehicles to attach to surfaces or transport other remotely controlled vehicles to regions of interest.

The crawler alone cannot eliminate all man-hours exposed to risk in the surface preparation process. Often, the area that needs to be prepared is in hard-to-reach locations. For example, the oil and gas industry has numerous large metallic structures, such as spherical vessels, cracking towers, and storage tanks for various liquids. Positioning the crawler on these structures involves risks, such as falls. Innovations aimed at mitigating these positioning risks can significantly complement the state of the art in crawlers.

Most surface preparation processes are performed using manual, mechanical, or blasting techniques, which require operators. The preparation work by these operators results in man-hours exposed to accident risk (HHER, as defined by ABNT NBR 14280), which can lead to medical leave, partial or permanent disability, or even death. It is important to note that it is not only the surface preparation process that results in man-hours exposed to accident risk. In hard-to-access locations, such as spherical vessels for liquefied gases, scaffoldings or suspended platforms must be installed to access the structure surface, further increasing HHER. Additionally, inspectors are needed to verify the prepared surface.

The present invention addresses the technical challenge commonly faced by the aforementioned structures, namely the process of corrosion and paint wear. The exposure of the surface to corrosive elements, such as humidity and aggressive chemicals, leads to the gradual loss of mass of the metal material, which in turn weakens and compromises its physical integrity and safety. To mitigate this corrosive process, periodic painting of metal structures is paramount. The application of a protective layer of paint forms an effective barrier between the metal surface and corrosive agents, extending the life of structures and reducing the interval between costly corrective maintenance. To achieve good paint durability, it is necessary to apply the coating on a properly prepared surface, by removing any contaminants such as oils, water, unknown particles, and corrosion products.

Specifically, the present invention proposes a system for the preparation of metal surfaces for subsequent painting. This system is composed of a set of a drone and a remotely controlled crawler capable of adhering to metal surfaces at any angle to the ground.

In view of this, and in order to solve the technical problems described above, the present invention offers advantages such as the use of robots capable of adhering to metal surfaces, generally ferromagnetic, able to move and perform surface preparation, since the surface preparation tools are mounted on the robot itself. This eliminates the need for human intervention and reduces surface roughness with less variability, resulting in better paint adhesion after treatment.

### State of the Art

There are systems in the state of the art that use crawlers, robots capable of adhering to metal surfaces, usually ferromagnetic, being able to move and perform preparation, since the surface preparation tools are coupled to the robot itself; however no system in the state of the art performs the preparation of metal surfaces for later painting by a set of a drone and a remotely controlled crawler capable of adhering to the metal surfaces at any angle to the ground that removes surface roughness, providing better paint adhesion after treatment.

Patent document CN110067368A, for example, relates to a type of unmanned flat wall cleaning device using radial roller movement. Its structure includes a cleaning device, fuselage, camera support controller, horn, propeller, piston spray mechanism cleaning device, through-hole nozzle housing, support, and rotary broom assembly. The effect of the present invention is as follows: by controlling the unmanned aerial vehicle during flight, it is engaged with the drive wheel and the rotary broom on the wall. Then, the unmanned aerial vehicle control moves vertically up or down, the drive wheel is adjusted to drive the roller rotation, which is rotated via the lever of the transmission belt shaft, causing the drive wheel to perform repeated circumferential movement. The piston is adjusted to perform a straight reciprocating motion along the piston cylinder, oil is discharged from the through-hole nozzle housing and sprayed onto the rolling rotary broom. The unmanned aerial vehicle moves vertically up or down and can apply a uniform coating of vegetable oil-based paint onto the wall via the rotary broom. The unmanned aerial vehicle, when moving vertically, is mounted on the wall using the drive wheel and rotary broom, improving stability during operation. This results in smoother lacquer painting of the wall.

However, document CN110067368A differs from the present invention, as it does not present an adhesion and movement system adapted to the needs of the operating environment composed of a crawler that operates in conjunction with a drone operating in a coupled or decoupled configuration.

In turn, document U.S. Pat. No. 11,498,090B2 relates to a drone (UAV) that includes a sprayer configured to generate a pressurized fluid flow and a nozzle configured to receive the pressurized fluid from the sprayer and to generate a spray fan to apply the fluid onto a surface. The UAV includes sensors and a control unit to control both UAV flight and spray spraying. The fluid can be stored onboard the UAV in a reservoir or can be stored remotely and pumped to the UAV. The UAV control unit can be pre-loaded with a spraying plan and a flight plan, or the UAV can be controlled by a user.

However, the present invention differs from the U.S. Pat. No. 11,498,090B2 document, as it presents a system composed of a crawler operating with a drone, having a system of adhesion to ferromagnetic metal surfaces, a locomotion system, an electronics system, a feeding system, at least one surface preparation equipment and at least one decoupling system for ferromagnetic metal surfaces.

### Brief description

The present invention relates to a drone-crawler system for preparing metal surfaces, comprising: a crawler (1) with autonomous or remote operation; a drone (2); an adhesion system to ferromagnetic metal surfaces (11); a magnetic adhesion means (111); a locomotion system (12); a motor (121); a wheel (122); a sensor (123); a support (124); a control system (13); a microcontroller (131); a radio frequency communication module (132); a protective casing (133); a power supply system (14); an energy storage means (141); a surface preparation system (15); a surface preparation equipment (151); a support (152); an actuator (153); a trigger (154); a decoupling system for ferromagnetic metal surfaces (16); an actuator (161); a support (162); a structural chassis (17); a structural chassis (21); a protective cover (22); a propulsion system (23); a motor (231); a propeller (232); a support (233); a flight control system (24); a flight control module (241); a radio frequency communication module (242); a GNSS module (243); a crawler coupling and decoupling system (25); a microcontroller module (251); a sensor (252); an actuator (253); a physical connection means (254); a rail (255); a sliding means (256); a power supply system (26); an energy storage means (261); a coupling system for ferromagnetic metal surfaces (27); a magnetic adhesion means (271); and an actuator (272), wherein said crawler coupling and decoupling system (25) performs a coupling between the crawler (1) and the drone (2), varying a position, said position being defined by the center of mass of the crawler (1) relative to the center of mass of the drone (2) in a given situation, wherein the drone (2) is coupled to a ferromagnetic metal surface by means of the coupling system for ferromagnetic metal surfaces (27), creating a static equilibrium that allows the crawler (1) to approach the ferromagnetic metal surface safely and stably. In addition, the physical connection means (254) is a four-bar self-locking mechanism. The magnetic adhesion means (111, 271) is neodymium magnets. In addition, the energy storage means (141, 261) is lithium batteries. Actuators (161, 253) are electric linear actuators. The control system (13) and the flight control system (24) operated the crawler (1) autonomously or remotely controlled. The ferromagnetic metal surface adhesion system (11) keeps the crawler (1) fixed to ferromagnetic metal surfaces at any angle to the ground, and the locomotion system (12) translates the crawler (1) across any ferromagnetic surface. The surface preparation system (15) comprises preparing surfaces for a subsequent application of a coating, and the decoupling system for ferromagnetic metal surfaces (16) comprises cancelling a magnetic adhesion force performed by the magnetic adhesion system (11). The coupling system for ferromagnetic metal surfaces (27), keeps and/or removes the drone (2) from a resting position on ferromagnetic metal surfaces. The claimed system performs takeoff and transport in a coupled configuration of the drone (2) and the crawler (1) to a ferromagnetic surface, with the drone (2) coupling to the ferromagnetic metal surface and the crawler (1) approaching the ferromagnetic metal surface, and transports in a decoupled configuration of the drone (2) to the ground, such that the crawler (1) remains on the ferromagnetic surface. Additionally, the system further performs takeoff and transport in a decoupled configuration of the drone (2) to a ferromagnetic metal surface, coupling the drone (2) to the ferromagnetic metal surface, retrieving the crawler (1), transporting it in a coupled configuration of the drone (2) and the crawler (1) to the ground.

### BRIEF DESCRIPTION OF THE DRAWINGS

To enhance this description and provide a clearer insight into the features of the present invention, a set of accompanying figures is included. These figures exemplify, though not exhaustively, the preferred embodiment.

FIG. 1 is an isometric view indicating the crawler (1) of the claimed system, comprising at least one surface adhesion system (11), a locomotion system (12), a control system (13), a power supply system (14), a surface preparation system (15), a decoupling system for ferromagnetic metal surfaces (16), and a structural chassis (17), according to a preferred embodiment of the present invention.

FIG. 2 is an isometric view indicating the surface adhesion system (11) of the crawler (1), comprising at least one magnetic adhesion means (111), and the locomotion system (12) of the claimed system, comprising at least one motor (121) that provides torque to the wheel (122), a sensor (123), and a support (124) that attaches the system to the structural chassis (17), according to a preferred embodiment of the present invention.

FIG. 3 is an isometric view indicating the control system (13) of the crawler (1), comprising at least one microcontroller (131), at least one radio frequency antenna (132), a protective casing (133), and an electrical energy storage means (141), according to a preferred embodiment of the present invention.

FIG. 4 is a side view indicating the surface preparation system (15) of the crawler (1), comprising at least one surface preparation tool (151), a support (152) that attaches the tool to the structural chassis (17), an actuator (153), and a trigger (154) responsible for remotely activating the surface preparation tool (151), according to a preferred embodiment of the present invention.

FIG. 5 is an isometric view indicating the decoupling system for ferromagnetic metal surfaces (16) of the crawler (1) in the retracted configuration, comprising at least one actuator (161) responsible for decoupling the crawler (1) from the ferromagnetic metal surface in the extended configuration, and a support (162), according to a preferred embodiment of the present invention.

FIG. 6 is an isometric view indicating the decoupling system for ferromagnetic metal surfaces (16) of the crawler (1) in the extended configuration, comprising at least one actuator (161) responsible for decoupling the crawler (1) from the ferromagnetic metal surface in the extended configuration, and a support (162), according to a preferred embodiment of the present invention.

FIG. 7 is an isometric view indicating the drone (2) of the claimed system, comprising at least one structural chassis (21), a protective casing (22), a propulsion system (23), a flight control system (24), a coupling and decoupling system (25), a power supply system (26), and a coupling system for ferromagnetic metal surfaces (27), according to a preferred embodiment of the present invention.

FIG. 8 is an isometric view indicating the propulsion system (23) of the drone (2), comprising at least one motor (231), a propeller (232) responsible for converting the motor torque into thrust enabling the drone (2) to fly, and a support (233) responsible for securing the system to the structural chassis (21), according to a preferred embodiment of the present invention.

FIG. 9 is an isometric view indicating the flight control system (24) of the drone (2), comprising at least one flight control module (241), responsible for assisting the pilot and ensuring safer flight, a radio frequency communication module (242), and a GNSS module (243). It also shows the coupling and decoupling system (25) of the drone (2), comprising at least one microcontroller module (251) and a sensor (252), responsible for assisting in the decision to couple or decouple the crawler (1), according to a preferred embodiment of the present invention.

FIG. 10 is a side view indicating the flight control system (24) of the drone (2), comprising at least one physical connection means (253), an actuator (254) responsible for enabling the movement of the sliding means (255) along a rail (256); indication of the power supply system (26) of the drone (2), comprising at least one energy storage means (261); and the coupling system for ferromagnetic metal surfaces (27) of the drone (2), comprising at least one magnetic adhesion means (271) and an actuator (272) responsible for decoupling the drone (2) from the ferromagnetic surface, according to a preferred embodiment of the present invention.

FIG. 11 is a not-to-scale representation indicating the coupled and decoupled operational configurations of the crawler (1) and drone (2) system, showing the coupled configuration in which the drone (2) is attached to the ferromagnetic surface, with the transition of the crawler (1) position toward the ferromagnetic surface, according to a preferred embodiment of the present invention.

FIG. 12 is a not-to-scale representation indicating the coupled operational configuration of the crawler (1) and drone (2) system, showing the coupled configuration in which the drone (2) is ready to takeoff and transport the crawler (1) to the ferromagnetic surface, according to a preferred embodiment of the present invention.

FIG. 13 is a not-to-scale representation indicating the coupled operational configuration of the crawler (1) and drone (2) system, showing the decoupled configuration in which the drone (2) is ready to takeoff and remove the crawler (1) from the ferromagnetic surface, according to a preferred embodiment of the present invention.

### DETAILED DESCRIPTION OF THE DRAWINGS

This invention relates to the technical field of maintenance of ships and offshore platforms, drilling platforms and storage tanks, storage spheres and other metal structures exposed to corrosive environments, being applied more specifically in cleaning processes, surface preparation and application of new coatings on ferromagnetic structures to prevent corrosion and ensure structural integrity.

Specifically, the present invention proposes a system consisting of a drone (2) and a crawler (1) that eliminates man-hours exposed to risk both in the preparation process and in the process of transporting and positioning the crawler (1) to the desired location. The present invention carries out the process of transporting and positioning a crawler (1) to the surface preparation site, the claimed system being a structure with a practical geometry that facilitates the movement of its base to the area to be prepared, without the need for human intervention to position it near the desired region.

In general, the present invention relates to a drone-crawler system for preparing ferromagnetic metal surfaces, comprising a crawler (1) and a drone (2) that can operate in both coupled and decoupled configurations, having at least one control system (13) capable of operating the crawler (1) autonomously or via remote control, at least one flight control system (24) capable of operating the drone (2) autonomously or via remote control, at least one crawler coupling and decoupling system (25) capable of coupling and decoupling the crawler (1) from the drone (2), at least one adhesion system for ferromagnetic metal surfaces (11) capable of keeping the crawler (1) fixed to ferromagnetic metal surfaces at any angle relative to the ground, at least one locomotion system (12) capable of moving the crawler (1) across any ferromagnetic surface, at least one power supply system (14) capable of providing energy to the crawler (1) systems, at least one surface preparation system (15) capable of preparing ferromagnetic metal surfaces for subsequent coating application, at least one decoupling system for ferromagnetic metal surfaces (16) capable of nullifying the magnetic adhesion force exerted by the magnetic adhesion system (11), at least one structural chassis (13) capable of securing all the crawler (1) systems, at least one power supply system (26) capable of providing energy to the drone (2) systems, at least one coupling system for ferromagnetic metal surfaces (27) capable of maintaining and removing the drone (2) from rest on ferromagnetic metal surfaces, and at least one structural chassis (21) and a protective cover (22) capable of securing and protecting the drone (2) systems.

In other words, the system of the present invention comprises a crawler (1), a drone (2), an adhesion system for ferromagnetic metal surfaces (11), a magnetic adhesion means (111), a locomotion system (12), a motor (121), a wheel (122), a sensor (123), a support (124), a control system (13), a microcontroller (131), a radio frequency communication module (132), a protective casing (133), a power supply system (14), an energy storage means (141), a surface preparation system (15), a surface preparation equipment (151), a support (152), an actuator (153), a trigger (154), a decoupling system for ferromagnetic metal surfaces (16), an actuator (161), a support (162), a structural chassis (17), a structural chassis (21), a protective cover (22), a propulsion system (23), a motor (231), a propeller (232), a support (233), a flight control system (24), a flight control module (241), a radio frequency communication module (242), a GNSS module (243), a crawler coupling and decoupling system (25), a microcontroller module (251), a sensor (252), an actuator (253), a physical connection means (254), a rail (255), a sliding means (256), a power supply system (26), an energy storage means (261), a coupling system for ferromagnetic metal surfaces (27), a magnetic adhesion means (271), and an actuator (272).

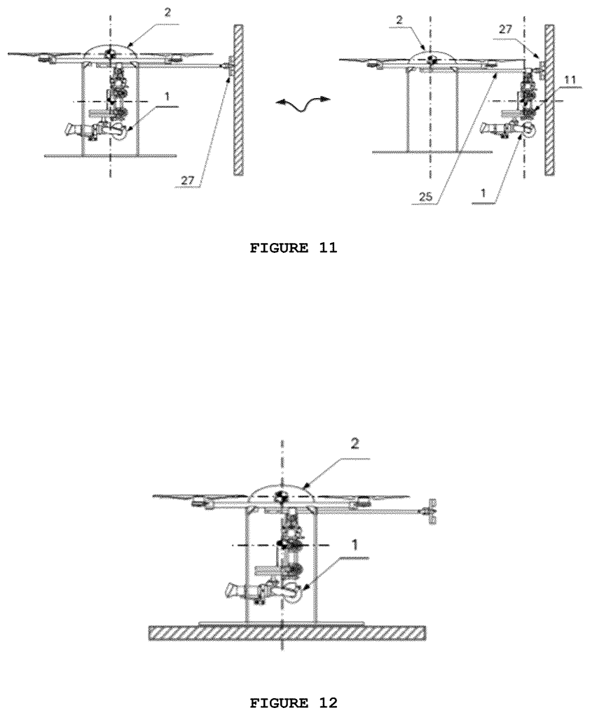

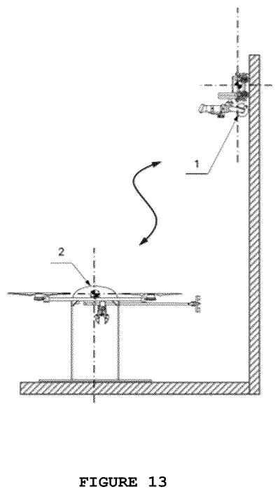

As seen in FIGS. 11, 12, and 13, the claimed system performs the typical mission of: takeoff and transport in the coupled configuration of the drone (2) and crawler (1) to the ferromagnetic surface, with the drone (2) coupling to the ferromagnetic metal surface and the crawler (1) approaching the ferromagnetic metal surface, and transport in the decoupled configuration of the drone (2) to the ground, such that the crawler (1) remains on the ferromagnetic surface. The steps can be performed in reverse order: takeoff and transport in the decoupled configuration of the drone (2) to the ferromagnetic metal surface, coupling of the drone (2) to the ferromagnetic metal surface, retrieval of the crawler (1), and transport in the coupled configuration of the drone (2) and crawler (1) to the ground.

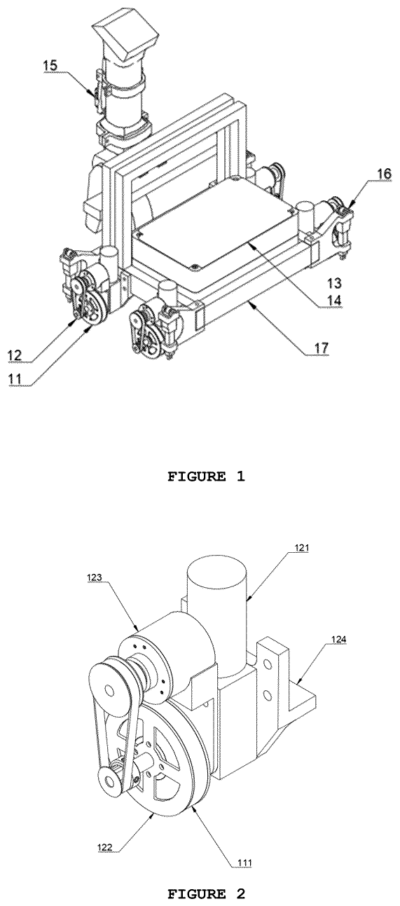

As seen in FIG. 1, the crawler (1) comprises the following components: an adhesion system for ferromagnetic metal surfaces (11), a locomotion system (12), a control system (13) configured to operate the vehicle autonomously or via remote control, a power supply system (14), a surface preparation system (15), at least one decoupling system for ferromagnetic metal surfaces (16), and a structural chassis (17).

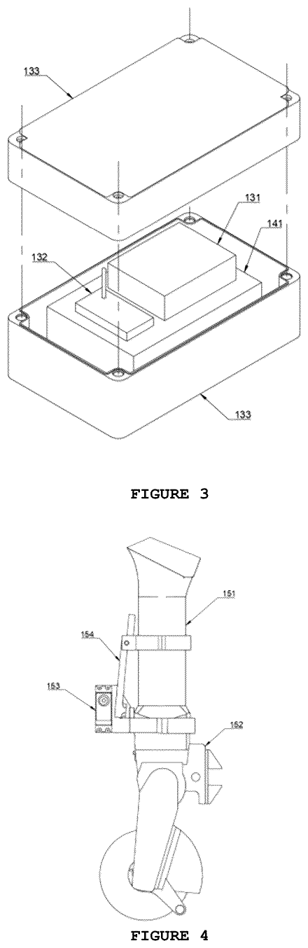

The adhesion system for ferromagnetic metal surfaces (11) comprises at least one magnetic adhesion means (111), capable of allowing the crawler to adhere to surfaces at any angle relative to the ground, as seen in FIG. 2.

The locomotion system (12) comprises at least one motor (121) that provides torque to the wheel (122), a sensor (123) capable of measuring the rotation of the wheel (122), and a support (124) capable of securing the system to a structural chassis, as seen in FIG. 2.

The control system (13) comprises at least one microcontroller module (131) capable of making decisions autonomously or under remote control, at least one radio frequency communication module (132) capable of transmitting information to a ground station, and a protective casing (133), as seen in FIG. 3.

The power supply system (14) comprises at least one energy storage means (141) capable of providing electrical energy, as seen in FIG. 3.

The surface preparation system (15) comprises at least one surface preparation equipment (151), a support (152) capable of securing the system to a structural chassis, an actuator (153) capable of activating a trigger (154), and a trigger (154) capable of remotely activating the surface preparation equipment (151), as seen in FIG. 4.

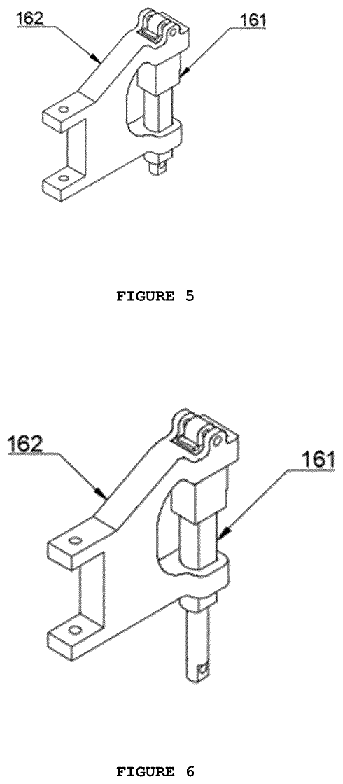

The decoupling system for ferromagnetic metal surfaces (16) comprises at least one actuator (161) capable of exerting a force equal and opposite to the magnetic adhesion force, and a support (162) capable of securing the system to a structural chassis, as seen in FIGS. 5 and 6.

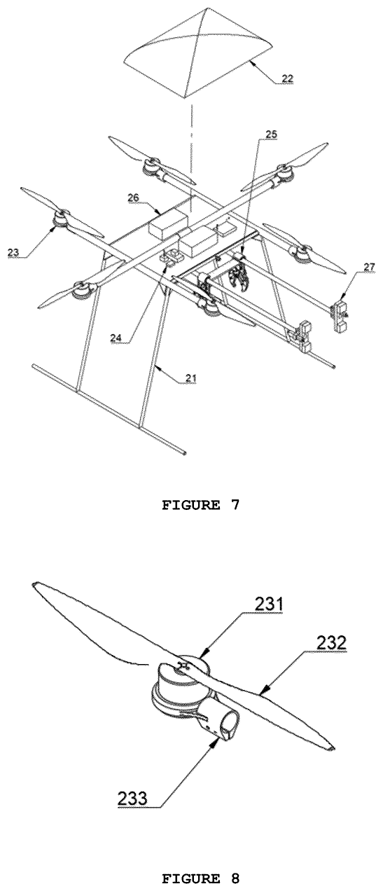

As seen in FIG. 7, the drone (2) further comprises: at least one structural chassis (21), a protective cover (22), a propulsion system (23), a flight control system (24) configured to operate the drone autonomously or via remote control, a crawler coupling and decoupling system (25) capable of autonomously or remotely coupling, decoupling, and transporting the crawler to the ferromagnetic surface, a power supply system (26), and a coupling system for ferromagnetic metal surfaces (27).

The propulsion system (23) comprises at least one motor (231) that provides torque to a propeller (232), and a support (233) capable of securing the system to a structural chassis, as seen in FIG. 8.

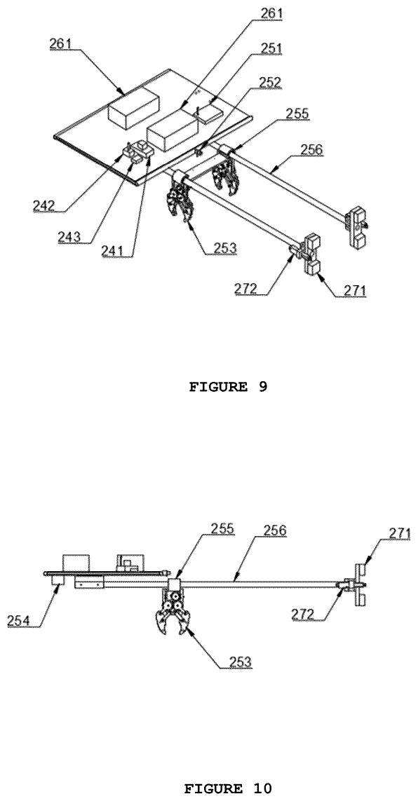

The flight control system (24) comprises at least one flight controller module (241) capable of making decisions autonomously or via remote control, at least one radio frequency communication module (242) capable of sending and receiving information, and at least one GNSS module (243) capable of providing the drone position in terrestrial coordinates, as seen in FIG. 9.

The crawler coupling and decoupling system (25) comprises at least one microcontroller module (251) capable of making decisions to couple or decouple the crawler (1) from the drone (2), at least one sensor (252) capable of assisting in the decision to couple or decouple the crawler (1) from the drone (2), a physical connection means (253) capable of securing the crawler (1) to the drone (2), and an actuator (254) capable of moving the sliding means (255) along a rail (256), as seen in FIG. 9.

The power supply system (26) comprises at least one energy storage means (261) capable of providing electrical energy, as seen in FIG. 9.

The coupling system for ferromagnetic metal surfaces (27) comprises at least one magnetic adhesion means (271), capable of securing the drone (2) to a ferromagnetic metal surface, and an actuator (272), capable of exerting a force equal to or greater than the magnetic adhesion means (271), as seen in FIG. 10.

Moreover, in a preferred embodiment of the present invention, the crawler (1) includes the following components: four units of the adhesion system for ferromagnetic metal surfaces (11), four units of the locomotion system (12), one unit of the control system (13), one unit of the power supply system (14), one unit of the surface preparation system (12), four units of the decoupling system for ferromagnetic metal surfaces (16), and one unit of the structural chassis (17).

The adhesion system for ferromagnetic metal surfaces (11) comprises at least one magnetic adhesion means (111) capable of allowing the crawler to adhere to ferromagnetic metal surfaces at any angle relative to the ground, as seen in FIG. 2.

The adhesion system for ferromagnetic metal surfaces (11), in a preferred embodiment, comprises one unit of the magnetic adhesion means (111), wherein the magnetic adhesion means (111) is a ring-shaped neodymium permanent magnet.

The locomotion system (12) comprises at least one motor (121) that provides torque to the wheel (122), a sensor (123) capable of measuring the rotation of the wheel (122), and a support (124) capable of securing the system to a structural chassis, as seen in FIG. 2.

The locomotion system (12), in a preferred embodiment, comprises one unit of the motor (121), wherein the motor (121) is a brushed direct current motor with a reduction gearbox.

The locomotion system (12), in a preferred embodiment, comprises one unit of the wheel (122), wherein the wheel (122) also serves as the magnetic adhesion means (111) being a ring-shaped neodymium permanent magnet.

The locomotion system (12), in a preferred embodiment, comprises one unit of the sensor (123), wherein the sensor (123) is an optical rotary encoder.

The control system (13) comprises at least one microcontroller (131) capable of inferring the distance traveled by the crawler (1), at least one radio frequency antenna (132) capable of transmitting and receiving information to and from a ground station, and a protective casing (133), as seen in FIG. 3.

The control system (13), in a preferred embodiment, comprises one microcontroller unit (131), wherein the microcontroller is an ESP32.

The power supply system (14) comprises at least one energy storage means (141) capable of providing electrical energy, as seen in FIG. 3.

The power supply system (14), in a preferred embodiment, comprises three units of the energy storage means (141), wherein the energy storage means (141) is an 18.5 V Li-Po battery with a capacity of 8,000 mAh.

The surface preparation system (15) comprises at least one surface preparation equipment (151), a support (152) capable of securing the system to a structural chassis, an actuator (153) capable of activating a trigger (154), and a trigger (154) capable of remotely activating the surface preparation equipment (151), as seen in FIG. 4.

The surface preparation system (15), in a preferred embodiment, comprises one unit of the surface preparation equipment (151), wherein the surface preparation equipment (151) is a rotary machine with an abrasive disc.

The surface preparation system (15), in a preferred embodiment, comprises one unit of the actuator (153), wherein the actuator (153) is a servo.

The decoupling system for ferromagnetic metal surfaces (16) comprises at least one actuator (161) capable of exerting a force equal and opposite to the magnetic adhesion force, and a support (162) capable of securing the system to a structural chassis, as seen in FIGS. 5 and 6.

The decoupling system for ferromagnetic metal surfaces (16), in a preferred embodiment, comprises one unit of the actuator (161), wherein the actuator (161) is a linear screw connected to a brushed direct current motor.

The drone (2) further comprises at least one structural chassis (21), a protective cover (22), a propulsion system (23), a flight control system (24) configured to operate the drone autonomously or via remote control, a crawler coupling and decoupling system (25) capable of autonomously or remotely coupling, decoupling, and transporting the crawler to the ferromagnetic metal surface, a power supply system (26), and a coupling system for ferromagnetic metal surfaces (27) capable of coupling and decoupling the drone (2) from ferromagnetic metal surfaces, as seen in FIG. 7.

The drone (2), in a preferred embodiment, comprises the following components: one unit of the structural chassis (21), one unit of the protective cover (22), six units of the propulsion system (23), one unit of the flight control system (24), one unit of the crawler coupling and decoupling system (25), one unit of the power supply system (26), and two units of the coupling system for ferromagnetic metal surfaces (27).

The propulsion system (23) comprises at least one motor (231) that provides torque to a propeller (232), and a support (233) capable of securing the system to a structural chassis, as seen in FIG. 8.

The propulsion system (23), in a preferred embodiment, comprises one unit of the motor (231), wherein the motor (231) is a brushless direct current motor.

The flight control system (24) comprises at least one flight controller module (241) capable of making decisions autonomously or via remote control, at least one radio frequency communication module (242) capable of sending and receiving information, and at least one GNSS module (243) capable of providing the drone's position in terrestrial coordinates, as seen in FIGS. 9 and 10.

The flight control system (24), in a preferred embodiment, comprises one unit of the flight controller module (241), wherein the flight controller module (241) is a commercial Pixhawk model.

The flight control system (24), in a preferred embodiment, comprises one unit of the radio frequency communication module (242), wherein the radio frequency communication module (242) is a 2.4 GHz Spektrum receiver.

The crawler coupling and decoupling system (25) comprises at least one microcontroller module (251) capable of making decisions to couple or decouple the crawler (1) from the drone (2), at least one sensor (252) capable of assisting in the decision to couple or decouple the crawler (1) from the drone (2), a physical connection means (253) capable of securing the crawler (1) to the drone (2), and an actuator (254) capable of moving the sliding means (255) along a rail (256), as seen in FIGS. 9 and 10.

The crawler coupling and decoupling system (25), in a preferred embodiment, comprises one unit of the microcontroller module (251), wherein the microcontroller module (251) is a Raspberry Pi.

The crawler coupling and decoupling system (25), in a preferred embodiment, comprises one unit of the sensor (252), wherein the sensor (252) is a camera.

The crawler coupling and decoupling system (25), in a preferred embodiment, comprises two units of the physical connection means (253), wherein the physical connection means (253) is a servo-controlled claw with a four-bar self-locking mechanism.

The crawler coupling and decoupling system (25), in a preferred embodiment, comprises one unit of the actuator (254), wherein the actuator (254) is a servo coupled to a timing belt.

The crawler coupling and decoupling system (25), in a preferred embodiment, comprises two units of the sliding means (255), wherein the sliding means (255) is a linear ball bearing.

The crawler coupling and decoupling system (25), in a preferred embodiment, comprises two units of the rail (256), wherein the rail (256) is a carbon fiber tube.

The power supply system (26) comprises at least one energy storage means (261) capable of providing electrical energy, as seen in FIGS. 9 and 10.

The power supply system (26), in a preferred embodiment, comprises three units of the energy storage means (261), wherein the energy storage means (261) is a 44.4 V Li-Po battery with a capacity of 9,500 mAh.

The coupling system for ferromagnetic metal surfaces (27) comprises at least one magnetic adhesion means (271) capable of securing the drone (2) to a ferromagnetic metal surface, and an actuator (272) capable of exerting a force equal to or greater than the magnetic adhesion means (271), as seen in FIGS. 9 and 10.

The coupling system for ferromagnetic metal surfaces (27), in a preferred embodiment, comprises 4 units of the magnetic adhesion means (271), wherein the magnetic adhesion means (271) is a neodymium permanent magnet.

The coupling system for ferromagnetic metal surfaces (27), in a preferred embodiment, comprises 2 units of the actuator (272), wherein the actuator (272) is a trapezoidal screw connected to a brushed direct current motor.

The crawler (1) is coupled to the drone (2) via the crawler coupling and decoupling system (25), through the physical connection means (253), wherein the physical connection means (253) is a servo-controlled claw with a four-bar self-locking mechanism.

The physical connection means (253), in a preferred embodiment, is a servo-controlled claw with a four-bar self-locking mechanism, such that the claw can be opened or closed according to the position of the crawler (1) relative to the drone (2).

To increase operational safety, the command to open or close the physical connection means (253), in a preferred embodiment, a servo-controlled claw with a four-bar self-locking mechanism, is performed non-autonomously.

In the coupled configuration, as seen in FIGS. 11, 12, and 13, the only allowed configuration for drone (2) flight is when the center of mass of the crawler (1) is aligned vertically with the center of mass of the drone (2), to ensure safe operation.

In the coupled configuration, as seen in FIGS. 11, 12, and 13, flight to the region of interest on the ferromagnetic metal surface is permitted only when the center of mass of the crawler (1) is aligned vertically with the center of mass of the drone (2).

In the coupled configuration, as seen in FIGS. 11, 12, and 13, the variation of the crawler (1) position relative to the drone (2) can only be performed when the drone (2) is adhered to the ferromagnetic metal surface by means of the adhesion means (271).

The variation of the crawler (1) position relative to the drone (2) is carried out by the crawler coupling and decoupling system (25), such that the actuator (254) moves the physical connection means (253) and the sliding means (255) along the rail (256), consequently moving the crawler (1), fixed to the physical connection means (253), until the adhesion system for ferromagnetic metal surfaces (11) of the crawler (1) contacts the ferromagnetic surface.

During the crawler (1) movement to the ferromagnetic surface, the drone (2) remains adhered to the ferromagnetic metal surface by means of the magnetic adhesion means (271), so that the change in the crawler (1) center of mass position does not create an unstable equilibrium condition, since the magnetic adhesion means (271) acts as a support point, generating a reaction force through friction.

The crawler (1) stops moving along the rail (256) upon contacting the adhesion system for ferromagnetic metal surfaces (11) with the ferromagnetic surface.

The physical connection means (253) is deactivated by the microcontroller module (251), changing the configuration of the crawler (1) and drone (2) assembly to the decoupled state, as seen in FIGS. 11, 12, and 13.

In the decoupled state, as seen in FIGS. 11, 12, and 13, after the crawler (1) adheres to the ferromagnetic surface, the drone (2) decouples from the ferromagnetic metal surface by means of the actuator (272), applying a force equal to or greater than the magnetic adhesion force exerted by the adhesion means (271).

In the decoupled state, as seen in FIGS. 11, 12, and 13, the drone (2) performs a safe and stable flight back to the takeoff point, while the crawler (1) remains fixed to the ferromagnetic surface.

After landing, the drone (2) may transport other crawler (1) units to other regions of interest on ferromagnetic metal surfaces if desired, so its use is not limited to a specific crawler (1) unit.

In the decoupled state, as seen in FIGS. 11, 12, and 13, the crawler (1) is adhered to the ferromagnetic metal surface via the adhesion system for ferromagnetic metal surfaces (11), such that its locomotion on the ferromagnetic metal surface is performed by the locomotion system (12) and decision-making for locomotion is performed by the control system (13).

The control system (13) of the crawler (1) is capable of processing information and operating in both autonomous and remote control modes, wherein the microcontroller module (131) receives, processes, and sends information to a ground station via the radio frequency communication module (132).

The sensor (123) assists in determining the position of the crawler (1) on the ferromagnetic surface, such that in a preferred embodiment, the sensor (123) is an optical rotary sensor.

The crawler (1) has an autonomous surface preparation mode that can be activated or deactivated by an operator through the radio frequency communication module (132) in conjunction with the microcontroller module (131), such that the surface preparation equipment (151) can be turned on or off remotely via the actuator (153) and trigger (154).

In any abnormal operating condition, the crawler (1) enters a safe mode, wherein the control system (13) halts all actions and keeps the crawler (1) static and adhered to the ferromagnetic surface.

Upon completion of the ferromagnetic surface preparation, the crawler (1) ceases operation and awaits the return of the drone (2).

As seen in FIGS. 11, 12, and 13, the drone (2) initiates flight in the decoupled state and moves to the region of interest on the ferromagnetic surface near the position of the crawler (1), such that the drone (2) couples to the ferromagnetic metal surface via the adhesion means (271).

The drone (2) remains stationary, and via the sensor (252), in a preferred embodiment a camera, the position of the crawler (1) relative to the drone (2) can be determined, such that upon knowing the relative position of the crawler (1) to the drone (2), the crawler (1) is maneuvered by the control system (13) to the position where coupling can occur, transitioning the crawler (1) and drone (2) assembly from the decoupled to the coupled state, as seen in FIGS. 11, 12, and 13.

The coupling of the crawler (1) with the drone (2) is performed by the physical connection means (253), in a preferred embodiment a servo-controlled claw with a four-bar self-locking mechanism, such that the crawler (1) is securely fixed to the drone (2).

The decoupling system for ferromagnetic metal surfaces (16) of the crawler, via the actuator (161), generates a force equal to or greater and opposite to the force generated by the adhesion means for ferromagnetic metal surfaces (111), such that the magnetic adhesion force on the crawler (1) is effectively nullified.

The crawler (1), with its magnetic adhesion force nullified and fixed to the physical connection means (253), allows the actuator (254) to move the sliding means (255) and the physical connection means (253) along the rail (256), so that the vertical axis of the crawler (1) center of mass coincides with the vertical axis of the drone (2) center of mass.

The drone (2) initiates flight in the coupled configuration, as seen in FIGS. 11, 12, and 13, to the desired landing location, ensuring that the vertical axes of the centers of mass of both the crawler (1) and the drone (2) remain aligned throughout the flight phase, guaranteeing safe and stable operation.

The crawler (1) is decoupled from the drone (2) by opening the physical connection means (253), preferably a servo-controlled claw with a four-bar self-locking mechanism, allowing the crawler (1) and drone (2) to separate after completing the preparation of a ferromagnetic surface.

The safety and robustness of the present invention, through its autonomous operation capability, attest to its innovative character, since prior art solutions do not actively vary the center of mass of the crawler (1) relative to that of the drone (2), as shown in FIGS. 11, 12, and 13.

In a system where the weight of the crawler (1) is of the same order of magnitude as that of the drone (2), varying the crawler (1) center of mass relative to the drone (2) center of mass is necessary to enable the coupling of the crawler (1) onto ferromagnetic metal surfaces. For safe transport flight, it is essential to maintain the centers of mass of the crawler (1) and drone (2) in close positions.

The variation in the vertical axis position of the crawler (1) center of mass occurs only when the drone (2) is stationary on the ground and at rest during coupling of the drone (2) with the ferromagnetic surface, so that during flight, the vertical axis position of the combined crawler (1) and drone (2) center of mass remains unchanged, as seen in FIGS. 11, 12, and 13.

There is a slight horizontal axis displacement between the centers of mass of the crawler (1) and drone (2) in the coupled configuration, as seen in FIGS. 11, 12, and 13, with the crawler (1) horizontal center of mass located below that of the drone (2). Consequently, in the decoupled configuration, the center of mass during the drone (2) flight is higher than during flight in the coupled configuration; however, this does not significantly alter flight characteristics, reinforcing safety and robustness.

What is claimed is:

1. A drone-crawler system for preparation of metal surfaces comprising:
a crawler with autonomous or remote operation;
a drone;
an adhesion system for ferromagnetic metal surfaces;
a magnetic adhesion means;
a locomotion system;
a motor;
a wheel;
a first sensor;
a first support;
a control system;
a microcontroller;
a radio frequency communicator module;
a protective casing;
a power supply system;
a first energy storage means;
a surface preparation system;
a surface preparation equipment;
a second support;
a first actuator;
a trigger;
a decoupling system for ferromagnetic metal surfaces;
a second actuator;
a third support;
a first structural chassis;
a second structural chassis;
a protective cover;
a propulsion system;
a motor;
a propeller;
a fourth support;
a flight control system;
a flight control module;
a radio frequency communication module;
a GNSS module;
a crawler coupling and decoupling system;
a microcontroller module;
a second sensor;
a third actuator;
a physical connection means;
a rail;
a sliding means;
a power supply system;
a second energy storage means;
a coupling system for ferromagnetic metal surfaces;
a magnetic adhesion means; and
a fourth actuator,
wherein said crawler coupling and decoupling system performs a coupling between the crawler and the drone, varying a position, said position being defined by the center of mass of the crawler relative to the center of mass of the drone in a given situation, wherein the drone is coupled to a ferromagnetic metal surface by means of the coupling system for ferromagnetic metal surfaces, creating a static equilibrium that allows the crawler to approach the ferromagnetic metal surface safely and stably.

2. The drone-crawler system of claim 1, wherein the physical connection means is a four-bar self-locking mechanism.

3. The drone-crawler system of claim 1, wherein the magnetic adhesion means is neodymium magnets.

4. The drone-crawler system of claim 1, wherein the energy storage means is lithium batteries.

5. The drone-crawler system of claim 1, wherein the second actuator and the third actuator are electric linear actuators.

6. The drone-crawler system of claim 1, wherein the control system and the flight control system operate the crawler autonomously or via remote control.

7. The drone-crawler system, of claim 1, wherein the adhesion system for ferromagnetic metal surfaces, keeps the crawler fixed to the ferromagnetic metal surfaces at any angle in relation to a ground, and the locomotion system translates the crawler across any ferromagnetic surface.

8. The drone-crawler system of claim 1, wherein the surface preparation system comprises preparing surfaces for a subsequent application of a coating, and the decoupling system for ferromagnetic metal surfaces comprises cancelling a magnetic adhesion force performed by the magnetic adhesion system.

9. The drone-crawler system of claim 1, wherein the coupling system for ferromagnetic metal surfaces keeps and/or removes the drone from rest on ferromagnetic metal surfaces.

10. The drone-crawler system of claim 1, wherein the claimed system performs takeoff and transport in a coupled configuration of the drone and the crawler to a ferromagnetic surface, with the drone coupling to the ferromagnetic metal surface and the crawler approaching the ferromagnetic metal surface, and transports in a decoupled configuration of the drone to a ground, such that the crawler remains on the ferromagnetic surface.

11. The drone-crawler system of claim 1, wherein the drone-crawler system further performs takeoff and transport in a decoupled configuration of the drone to a ferromagnetic metal surface, coupling the drone to the ferromagnetic metal surface, retrieving the crawler, transporting it in a coupled configuration of the drone and the crawler to a ground.
